(19) United States
(12) Patent Application Publication
(10) Pub. No.: US 2013/0322700 A1
(43) Pub. Date: Dec. 5, 2013

(54) COMMODITY RECOGNITION APPARATUS AND COMMODITY RECOGNITION METHOD

(71) Applicant: TOSHIBA TEC KABUSHIKI KAISHA, Tokyo (JP)

(72) Inventors: Hiroshi Sugasawa, Miyagi-ken (JP); Hitoshi Iizaka, Shizuoka-ken (JP); Hidehiro Naito, Shizuoka-ken (JP)

(73) Assignee: TOSHIBA TEC KABUSHIKI KAISHA, Tokyo (JP)

(21) Appl. No.: 13/868,203

(22) Filed: Apr. 23, 2013

(30) Foreign Application Priority Data
May 31, 2012 (JP) 2012-124917

(51) Int. Cl. G06K 9/62

(52) U.S. Cl. CPC G06K 9/6202
USPC 382/110

(57) ABSTRACT

According to one embodiment, a commodity recognition apparatus includes a feature amount extraction module, a commodity recognition module and an output module. The feature amount extraction module extracts appearance feature amount of a commodity contained in an image photographed. The commodity recognition module compares data of the appearance feature amount extracted by the feature amount extraction module with the feature amount data of each part of the commodity, representing surface information of each part of the commodity subject to the recognition, that is previously stored in a recognition dictionary file, to recognize the commodity as a candidate of registration commodity contained in the image photographed. The output module outputs the recognition result of the commodity recognition module.

### CROSS-REFERENCE TO RELATED APPLICATION

This application is based upon and claims the benefit of priority from the prior Japanese Patent Application No. 2012-124917, filed on May 31, 2012, the entire contents of which are incorporated herein by reference.

### FIELD

Embodiments described herein relate to a commodity recognition apparatus using an image capturing unit and a commodity recognition method.

### BACKGROUND

There is a known technology in which, from the image data of a target article (object) photographed by an image capturing unit, a feature amount of the article is extracted, the feature amount extracted is compared with feature amount data registered in a recognition dictionary to calculate a similarity degree, and category of the article is determined according to the similarity degree. The recognition technology of an object contained in such an image is referred to as a general object recognition, which is carried out with various recognition methods that are respectively illustrated in the following documents:

YANAI Keiji, ‘Current status and future directions on General Object Recognition’, in Proceedings of Information Processing Society of Japan, Vol. 48, No SIG 16, In URL:http://mm.cs.uec.ac.jp/IPSJ-TCVIM-Yanai.pdf [retrieved on Aug. 10, 2010].

In addition, the technology for recognizing a general object by the area-segmentation of image on each object is described in the following document:

Jamie Shotton: “Semantic Texton Forests for Image Categorization and Segmentation, In URL:http://citeseerx.ist.psu.edu/viewdoc/download?doi=10.1.1.145.3036&rep=rep1&type=pdf (retrieved on Aug. 10, 2010).

In recent years, it is proposed to apply a general object recognition technology to an apparatus for recognizing commodities purchased by a customer in a store checkout system (POS system). In this case, feature amount data is stored in a recognition dictionary which represents surface information of each commodity, such as, an external shape, a tint (hue), a pattern, a surface roughness and the like, in the form of parameters. Moreover, in a commodity recognition apparatus, the feature amount concerning the surface information of a commodity is extracted from the image data of the commodity photographed by an image capturing unit and then is compared with feature amount data of each commodity registered in the recognition dictionary. Consequentially, if feature amount data having a similarity degree greater than a given threshold is detected, then the commodity having the subject feature amount data is output as a candidate of recognition commodity.

There are commodities respectively having many parts similar in appearance to one another. For example, radish and turnip are both root crops of family Cruciferae and are therefore similar in leaf. In addition, radish and turnip have respective root portions the shape of which are different but the tint and the surface of which are similar to one the other. Thus, there is a possibility that radish and turnip are recognized incorrectly if the recognition is performed based on unsuitable images of radish and turnip captured by the image capturing unit.

### BRIEF DESCRIPTION OF THE DRAWINGS

FIG. 1 is an external view of a store checkout system according to an embodiment;

FIG. 2 is a block diagram showing the hardware configuration of a commodity reading apparatus and a POS terminal of the store checkout system;

FIG. 3 is a schematic diagram illustrating the data structure of a recognition dictionary file used in the store checkout system;

FIG. 4 is a schematic diagram illustrating the feature amount data for each part division which is set in the recognition dictionary file shown in FIG. 3;

FIG. 5 is a block diagram showing the functions realized by the CPU of a commodity reading apparatus of the store checkout system when a commodity recognition mode is selected in the commodity reading apparatus;

FIG. 6 is a flowchart showing the procedure of an information processing executed by the CPU of the commodity reading apparatus of the store checkout system according to a commodity recognition program;

FIG. 7 is a flowchart specifically showing the procedure of the recognition processing of the ACT ST5 shown in FIG. 6;

FIG. 8 is a schematic diagram illustrating the data structure of a recognition dictionary file used in the store checkout system according to a second embodiment;

FIG. 9 is a flowchart specifically showing the procedure of the recognition processing of an information processing executed by the CPU of a commodity reading apparatus according to a commodity recognition program in the second embodiment; and

FIG. 10 is a flowchart specifically showing the procedure of the recognition processing of an information processing executed by the CPU of a commodity reading apparatus according to a commodity recognition program in a third embodiment.

### DETAILED DESCRIPTION

In general, according to one embodiment, a commodity recognition apparatus includes a feature amount extraction module, a commodity recognition module and an output module. The feature amount extraction module extracts appearance feature amount of a commodity contained in an image photographed. The commodity recognition module compares data of the appearance feature amount extracted by the feature amount extraction module with the feature amount data of each part of the commodity, representing surface information of each part of the commodity subject to the recognition, that is previously stored in a recognition dictionary file, to recognize the commodity as a candidate of registration commodity contained in the image photographed. The output module outputs the recognition result of the commodity recognition module.

Embodiments are described in detail below with reference to the accompanying drawings. In the present embodiments, the commodity reading apparatus 1 used in the store checkout system (POS system) has a function acting as a commodity recognition apparatus.

### First Embodiment

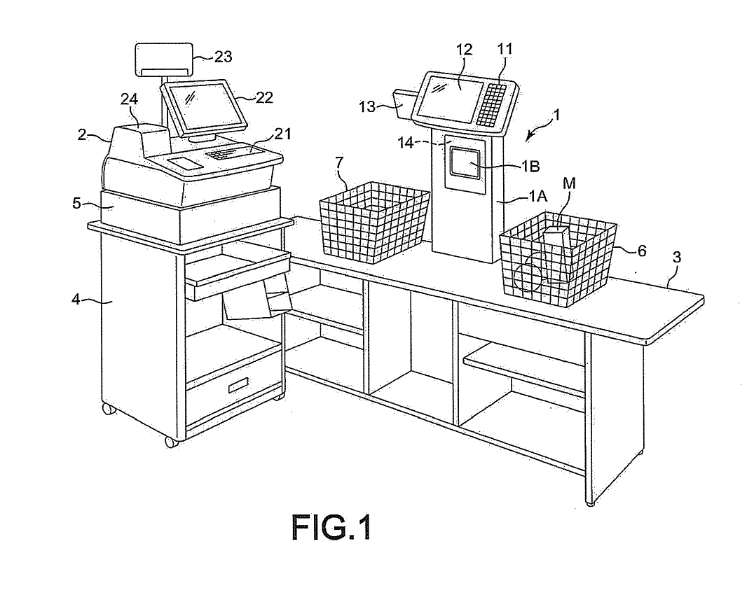

A first embodiment is described in detail with reference to FIG. 1 to FIG. 7.

FIG. 1 is an external view of a store checkout system. The system includes a commodity reading apparatus 1 functioning as a registration section for registering commodities purchased by a customer and a POS (Point Of Sales) terminal 2 functioning as a settlement section for processing payment by the customer. The commodity reading apparatus 1 is arranged on a checkout counter 3. The POS terminal 2 is mounted on a register counter 4 through a cash box 5. The commodity reading apparatus 1 is electrically connected with the POS terminal 2 through a communication cable (not shown in Figs.).

The commodity reading apparatus 1 is provided with a keyboard 11, a touch panel 12 and a display for customer 13. Such display operation devices (keyboard 11, touch panel 12 and display for customer 13) are arranged on a housing 1A formed in a thin rectangular shape constituting the main body of the commodity reading apparatus 1.

An image capturing module 14 is arranged in the housing 1A as an image capturing section. A reading window 1B formed in a rectangular shape is provided at the front side of the housing 1A. The image capturing module 14 comprises a CCD (Charge Coupled Device) photographing element serving as an area image sensor and the drive circuit thereof and a photographing lens for focusing the image of a photographing area on the CCD photographing element. The photographing area refers to the area of a frame image that is =focused on the area of the CCD photographing element through the reading window 1B. The image capturing module 14 outputs the image of the photographing area focused on the CCD photographing element through the photographing lens.

The POS terminal 2 is provided with a keyboard 21, a display for operator 22, a display for customer 23 and a receipt printer 24 as devices required to settlement.

The checkout counter 3 is formed in an elongated shape along a customer passage extending at the backside thereof in FIG. 1. The register counter 4 is arranged in a substantially right angle to the checkout counter 3 at the end part of the checkout counter 3 located at the downstream side in the movement direction of a customer moving along the checkout counter 3. As shown in FIG. 1, the checkout counter 3 and the register counter 4 define a space for a cashier, that is, a person in charge of accounting.

At the substantially center portion of the checkout counter 3, the housing 1A of the commodity reading apparatus 1 is vertically arranged such that the keyboard 11, the touch panel 12 and the reading window 1B are oriented to the cashier positioned at the space. The display for customer 13 of the commodity reading apparatus 1 is arranged on the housing 1A in such a manner that the display for customer 13 faces the customer passage.

The upper surface of the checkout counter 3 located at the upstream side of the commodity reading apparatus 1 in the moving direction of a customer forms a space for receiving a shopping basket 6 in which commodities M purchased by a customer but not registered are placed. The upper surface of the checkout counter 3 located at the downstream side of the commodity reading apparatus 1 forms another space for receiving another shopping basket 7 in which commodities M registered by the commodity reading apparatus 1 are placed.

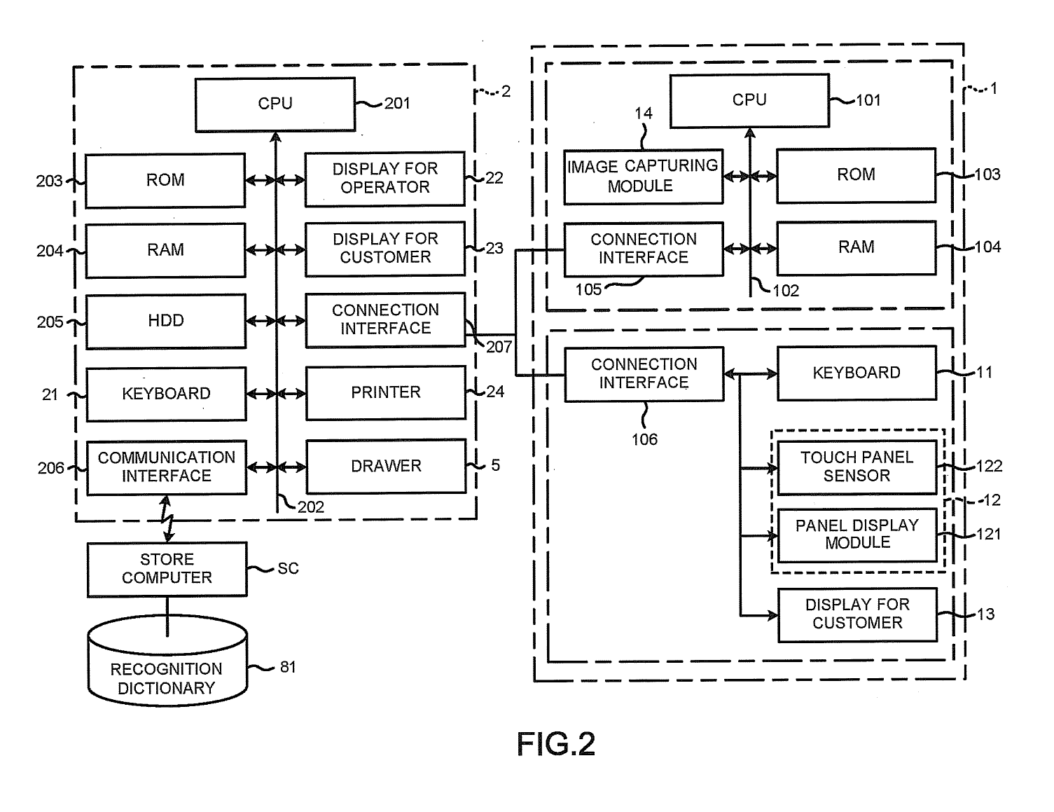

FIG. 2 is a block diagram showing the hardware configuration of the commodity reading apparatus 1 and the POS terminal 2. A CPU (Central Processing Unit) 101 acting as a control section is carried in the commodity reading apparatus 1. A ROM 103 and a RAM 104 are connected with the CPU 101 via a bus line 102 such as an address bus line or a data bus line. The ROM 103 stores programs executed by the CPU 101.

The bus line 102 is connected with the image capturing module 14 via various input/output circuits (not shown in Figs.). The keyboard 11, the touch panel 12 and the display for customer 13 are connected with the bus line 102 via a connection interfaces 105 and 106. The touch panel 12 is equipped with a panel display module 121 such as a liquid crystal display and a touch panel sensor 122 laminated on the screen of the display module 121.

A CPU 201 is also carried in the POS terminal 2 as the main body of a control section. A ROM 203, a RAM 204, an HDD (Hard Disk Drive) device 205, a communication interface 206 and a connection interface 207 are connected with the CPU 201 via a bus line 202. The keyboard 21, the display for operator 22, the display for customer 23, the printer 24 and the drawer 5 are respectively connected with the bus line 202 via input/output circuits (not shown).

The communication interface 206 is connected, through a network such as a LAN (Local Area Network), with a store computer SC. Through this connection, the POS terminal 2 is able to perform transmission/reception of data with the store computer SC. For example, the POS terminal 2 receives a commodity data file (not shown) and a recognition dictionary file 81 from the store computer SC. The commodity data file and recognition dictionary file 81 received are stored in the HDD device 205.

The connection interface 207 is connected with the connection interfaces 105 and 106 of the commodity reading apparatus 1 via a communication cable. Through this connection, the POS terminal 2 receives the commodity information read by the commodity reading apparatus 1. The commodity reading apparatus 1 is able to access to the commodity data file and the recognition dictionary file 81 stored in the HDD device 205.

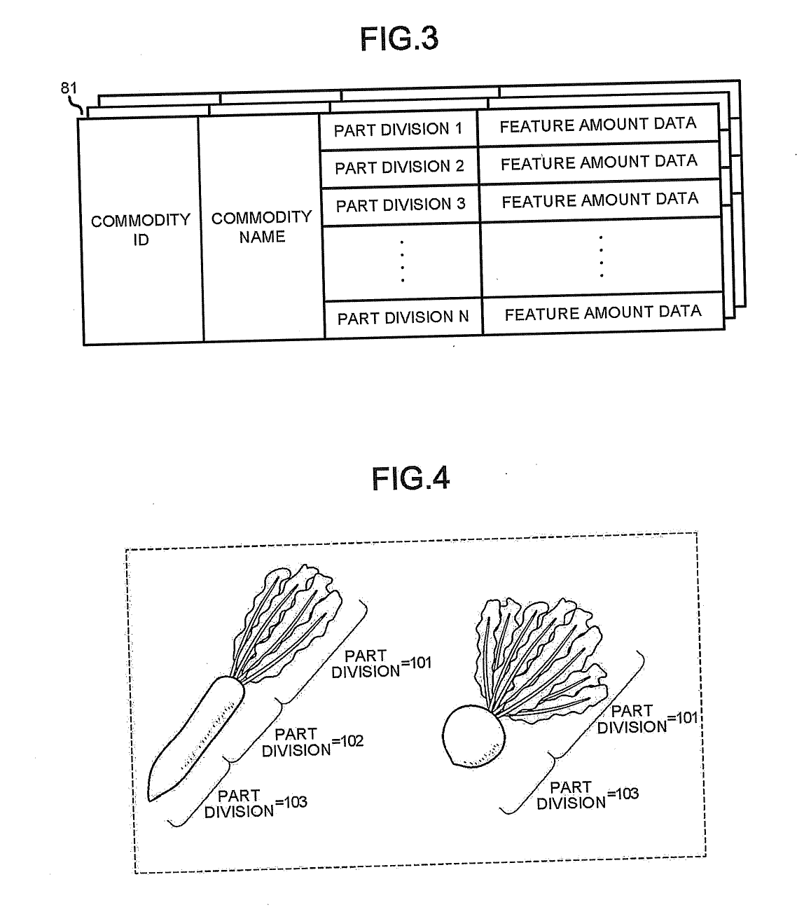

FIG. 3 is a schematic diagram illustrating the data structure of a data record in the recognition dictionary file 81. As shown in FIG. 3, the recognition dictionary file 81 includes a data record, in which feature amount data of all part divisions 1-N, is recorded in association with the commodity ID and the commodity name for distinguishing each commodity (recognition object).A unique commodity ID is assigned to each commodity sold in a store. In the commodity data file, commodity information including a commodity name, a unit price, a category code and the like is preset in association with the commodity ID of each commodity.

The feature amount data in each part division of a commodity distinguished by the commodity ID represents surface information, including the external shape, the tint, the pattern, the concave-convex condition (surface roughness) and the like, of the part distinguished by the part division of the commodity in the form of parameters. Part divisions of a commodity are illustrated with reference to FIG. 4.

In FIG. 4, an illustration at the left-hand side is a commodity ‘radish’, and an illustration at the right-hand side is a commodity ‘turnip’. The commodities ‘radish’ and ‘turnip’ are both root crops of family cruciferae and are both roughly divided into a leaf part and a root part. The root part of the commodity ‘radish’ is divided into a green head part close to the leaf part and a white root part away from the leaf part. The root part of the commodity ‘turnip’ is also called the white root part. Thus, for the commodity ‘radish’, feature amount data is recorded according to a part division ‘101’ representing the leaf part, a part division ‘102’ representing the green head part and a part division ‘103’ representing the white root part, respectively. On the other hand, for the commodity ‘turnip’, feature amount data is recorded according to the part division ‘101’ representing the leaf part, and the part division ‘103’ representing the white root part, respectively. That is, the number N of the part divisions is different according to commodities.

The commodity reading apparatus 1 includes at least a commodity recognition mode as an operation mode, in which commodities purchased by a customer are recognized and the result of the recognition is output to the POS terminal 2.

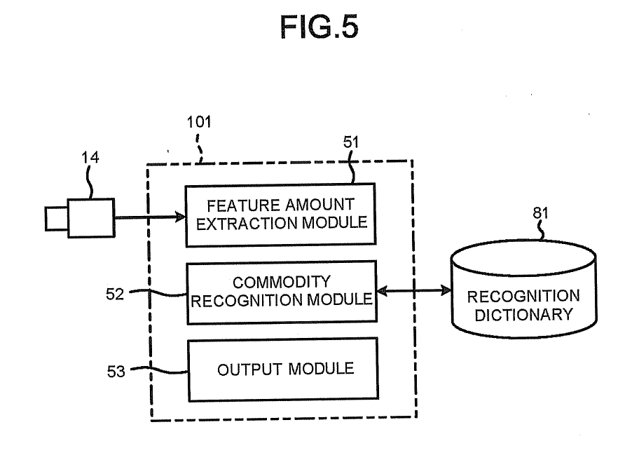

In the case that the commodity recognition mode is selected, the CPU 101 realizes functions, shown in the block diagram of FIG. 5, including a feature amount extraction module 51, a commodity recognition module 52 and an output module 53, which are all realized in accordance with a commodity recognition program (not shown) stored in the ROM 103 acting as a program memory section.

The feature amount extraction module 51 extracts, from an image captured by the image capturing module 14, the appearance feature amount concerning the surface information of the commodity, such as the external shape, the tint, the concave-convex condition (surface roughness) and the like, contained in the image captured. The commodity recognition module 52 compares the data of the appearance feature amount extracted by the feature amount extraction module 51 with the feature amount data of each part division (feature amount data of each part) contained in the recognition dictionary file 81 to recognize the commodity contained in the image. In more detail, for the feature amount data of each part division contained in the recognition dictionary file 81, a similarity degree representing how much similar an appearance feature amount is to the feature amount data of the part division is calculated, and the commodity contained in the image is recognized based on the similarity degree of the feature amount data of each part division. Specifically, the similarity degree of the feature amount data of each part division of the commodity is summed for each commodity, if the sum of similarity degrees is higher than a given threshold, then the commodity having the feature amount data of each part division thereof is determined to be a recognition candidate, otherwise, the commodity is determined not to be a recognition candidate. The output module 53 outputs the recognition result of the commodity recognition module 52, that is, information of the commodity that is determined to be a recognition candidate. Additionally, the output includes display of the recognition result or transmission of the recognition result to an external apparatus (e.g. the POS terminal 2).

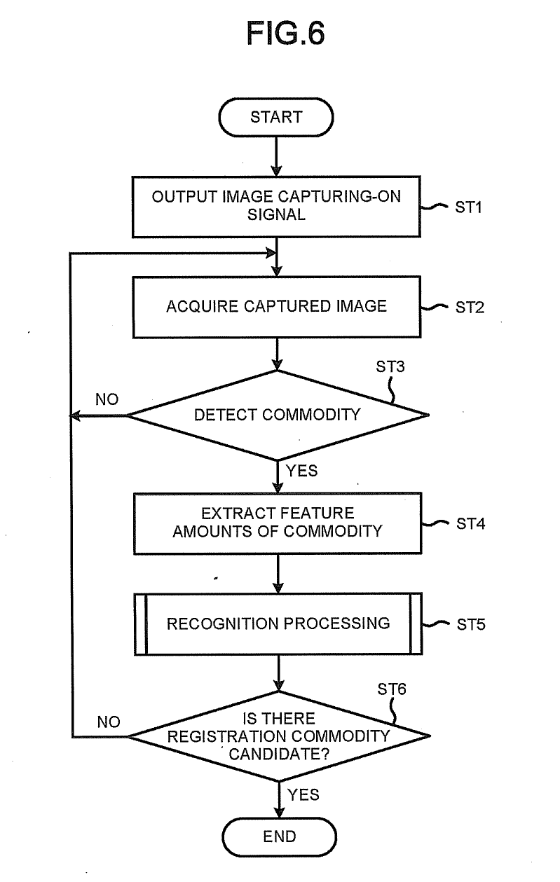

FIG. 6 is a flowchart illustrating the main procedures of an information processing executed by the CPU 101 when a commodity recognition mode is selected. A commodity recognition program runs when the commodity recognition mode is selected. The CPU 101 outputs an image capturing-on signal to the image capturing module 14 (ST1). The image capturing module 14 starts to photograph a photographing area in response to the image capturing-on signal. The frame images of the photographing area captured by the image capturing module 14 are sequentially stored in the RAM 104.

The CPU 101 acquires the data of the frame image stored in the RAM 104 (ST2). Then, the CPU 101 confirms whether or not a commodity 2Q is contained in the frame image (ST3). Specifically, the CPU 101 extracts an outline from an image that the frame image is binarized. Then, the CPU 101 tries to extract the outline of an object imaged in the frame image. If the outline of the object is extracted, then the CPU 41 regards the image in the outline as a commodity.

If no commodity is contained in the frame image (NO in ST3), then the CPU 101 acquires the next frame image from the RAM 104 (ST2). Contrarily to this, if a commodity is contained in the frame image (YES in ST3), the CPU 101 extracts the appearance feature amount of the commodity, such as, the shape, the surface hue, the pattern, the concave-convex condition and the like from the image in the outline (ST4: feature amount extraction module 51). The data of the extracted appearance feature amount is temporarily stored in the working area of the RAM 104.

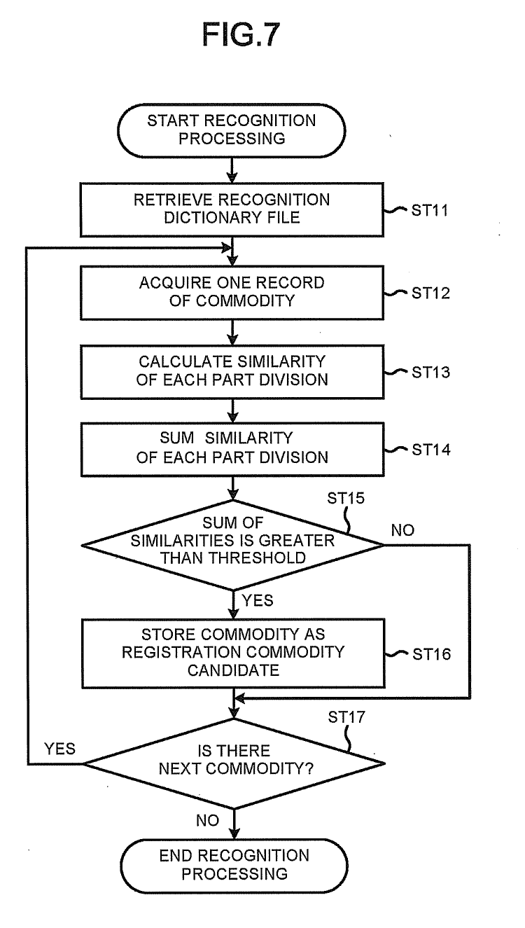

When the extraction on the feature amount is ended, then the CPU 101 executes the recognition processing specifically illustrated in the flowchart of FIG. 7 (ST5: commodity recognition module 52). The CPU 101 accesses the HDD device 205 of the POS terminal 2 connected via the connection interface 105 to retrieve the recognition dictionary file 81 (ST11). The CPU 101 reads the data record (commodity ID, commodity name, feature amount data of each part division) of one commodity from the recognition dictionary file 81 (ST12).

After reading the data record, the CPU 101 calculates, for the feature amount data of each part division contained in the record, a similarity degree representing how much similar the appearance feature amount extracted in the ACT ST4 are to the feature amount data of each part division contained in the record (ST13).

When each similarity degree is calculated for the feature amount data of each part division, the similarity degrees of the feature amount data of part divisions are summed by the CPU 101 (ST14). Sequentially, the CPU 101 determines whether or not the sum of similarity degrees is higher than a given threshold (ST15)

If the sum of similarity degrees is higher than the threshold (YES in ST15), then the CPU 101 stores the commodity ID and the commodity name of the commodity subject to the recognition recorded in the data record in a given area of the RAM 104 as a candidate of registration commodity (ST16). If the sum of similarity degrees is not higher than the threshold (NO in ST15), the CPU 101 does not execute the processing of the ACT ST16.

After the processing of the ACT ST16 is ended, or a result ‘NO’ is taken in the ACT ST15, the CPU 101 confirms whether or not there is an unprocessed data record in the recognition dictionary file 81 (ST17). If there is an unprocessed data record in the recognition dictionary file 81 (YES in ST17), the CPU 101 returns to the processing of the ACT ST12. That is, the CPU 101 reads the unprocessed data record from the recognition dictionary file 81 to execute the processing shown in the ACTs ST13-ST17.

When the processing shown in the ACTs ST13-ST17 is carried out on each data record stored in the recognition dictionary file 81 (NO in ST17), then the recognition processing is ended.

When the recognition processing is ended, the CPU 101 determines whether or not there is a candidate of registration commodity (recognition candidate) (ST6). If none of the commodity ID and the commodity name of a commodity serving as a registration commodity candidate is stored in the given area of the RAM 104, then it is determined that there is no registration commodity candidate (No in ST6). The CPU 101 returns to the processing of the ACT ST2. That is, the CPU 101 acquires data of the next frame image from the RAM 104. Then, the CPU 101 executes the processing shown in the ACTs ST3-ST6 for the image data acquired.

On the other hand, if the commodity ID and the commodity name of at least one commodity is stored in the given area of the RAM 104, it is determined that there is a registration commodity candidate (YES in ST6). The CPU 101 proceeds to execute the next processing. For example, a list of registration commodity candidate is displayed on the touch panel 12 (output module 53) to enable a user to select one commodity candidate optionally.

In the present embodiment, the feature amount data of each part division representing the surface information in each part of a commodity subject to the recognition is stored in the recognition dictionary file 81. The commodity reading apparatus 1 is able to access to the recognition dictionary file 81.

The shop clerk who is in charge of settlement (cashier), takes out, one by one, unregistered commodities M purchased by the customer from the shopping basket 6, and holds the commodity over the reading window 1B of the commodity reading apparatus 1. In this manner, the commodity M is photographed by the image capturing module 14, and the image data of the commodity M is taken into the commodity reading apparatus 1.

The commodity reading apparatus 1 extracts the appearance feature amount of the commodity M such as the shape, the surface hue, the pattern, the concave-convex condition and the like from the image data of the commodity M. Then, the data of the appearance feature amount extracted is compared with the feature amount data of each part division of each commodity stored in the recognition dictionary file 81.

For example, ‘radish’ is exemplarily described as a commodity M. For the commodity ‘radish’, the feature amount data of each part division of the commodity “radish” is previously stored in the recognition dictionary file 81 in association with a part division ‘101’ representing a leaf part, a part division ‘102’ representing a green head part and a part division ‘103’ representing a white root part, correspondingly. For a commodity ‘turnip’ which is a root crop of family cruciferae the same as the commodity ‘radish’ also, the feature amount data of each part division thereof is previously stored in the recognition dictionary file 81 in association with the part division ‘101’ representing the leaf part and the part division ‘103’ representing the white root part, correspondingly. However, no feature amount data of the part division ‘102’ representing the green head part is stored for the commodity ‘turnip’.

Assuming that the whole of the commodity ‘radish’ is photographed by the image capturing module 14. Apparently, in this case, the leaf part, the green head part and the white root part of the commodity ‘radish’ are shown in the image photographed. The similarity degree between the feature amount of each of the commodity surface information extracted from the image and the feature amount data of each part division of the commodity ‘radish’ recorded in the recognition dictionary file 81 rises. Contrary to this, the similarity degree between the feature amount of each of the same commodity surface information (radish) extracted from the image and the feature amount data of each part division of the commodity ‘turnip’ contained in the recognition dictionary file 81 is lower than the similarity degree for the commodity ‘radish’ in the both of the leaf part and the white root part because of the image including the green head part. As a result, even almost all the appearance parts of commodities are identical such as “radish” and “turnip”, the commodity reading apparatus 1 can distinguish the commodity ‘radish’ from the commodity ‘turnip’ at a high probability.

Assuming that the leaf part and the green head part of the commodity ‘radish’ are photographed by the image capturing module 14, while almost all the white root part thereof is not photographed. In this case also, since the leaf part and the green head part of the commodity ‘radish’ are contained in the image, the similarity degrees between the feature amount of each of the commodity surface information extracted from the image and the feature amount data of the leaf part and the green head part of the commodity ‘radish’ rise. Contrary to this, the similarity degrees between the feature amount of each of the same commodity surface information and the feature amount data of each part division of the commodity ‘turnip’ are lower compared with the similarity degree for the commodity ‘radish’ because of the green head part contained in the image photographed. The same result is also obtained in case that the green head part and the white root part of the commodity ‘radish’ are photographed by the image capturing module 14. Thus, the commodity reading apparatus 1 can recognize a commodity at a high probability even if the commodity is not wholly photographed by the image capturing module 14.

### Second Embodiment

In the first embodiment, each similarity degree between the feature amount data of each of a plurality of part divisions of one commodity and the feature amount of each of the commodity surface information extracted from a captured image is calculated, and a determination is made on whether or not the sum of the similarities is higher than a given threshold to recognize the commodity. Thus, in some cases depending on the captured part of the commodity, there is a possibility that other commodities which are similar in appearance with the recognition object (commodity) are incorrectly recognized as a candidate of commodity to be registered.

For example, it is assumed that a commodity ‘turnip’ is photographed by the image capturing module 14. In this case, the leaf part and the white root part of the commodity ‘turnip’ are shown in the image. Thus, each similarity degree between the feature amount of each of the commodity surface information extracted from the captured image and feature amount data of the commodity ‘turnip’ recorded in the recognition dictionary file 81 rises in both the leaf part and the white root part thereof. Likewise, the each similarity degree between the feature amount of each of the same commodity surface information extracted from the image and feature amount data of the commodity ‘radish’ recorded in the recognition dictionary file 81 rises in both the leaf part and the white root part thereof. Thus, the commodity reading apparatus 1 can hardly determine whether the commodity photographed by the image capturing module 14 is ‘turnip’ or ‘radish’.

However, the feature amount data of part division of green head part that is a specific part of the commodity ‘radish’ is contained in the feature amount data of a part division of the commodity ‘radish’ recorded in the recognition dictionary file 81. If the commodity photographed by the image capturing module 14 is ‘turnip’, then the similarity degree between the feature amount data of the commodity surface information and the feature amount data of part division of the green head part is low, almost to 0%. On the other hand, if the commodity photographed by the image capturing module 14 is ‘radish’, then the similarity degree between the feature amount data of the commodity surface information and the feature amount data of part division of the green head part is not always 0%. That is, in the commodity reading apparatus 1, even if the similarity degrees of the leaf parts and the white root parts of commodities ‘radish’ and ‘ turnip’ are substantially the same, if the similarity degree of the green head part is high, then the commodity read is recognized as ‘radish’, or if the similarity degree of the green head part is 0%, then the commodity is not recognized as ‘radish’.

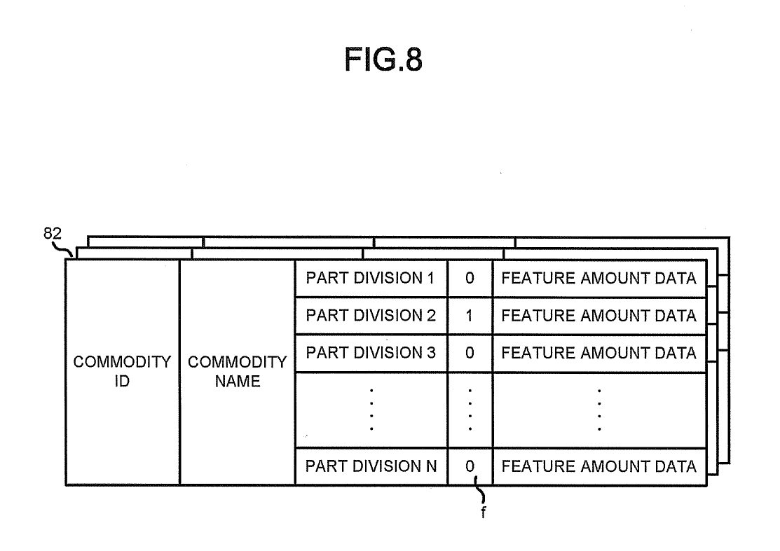

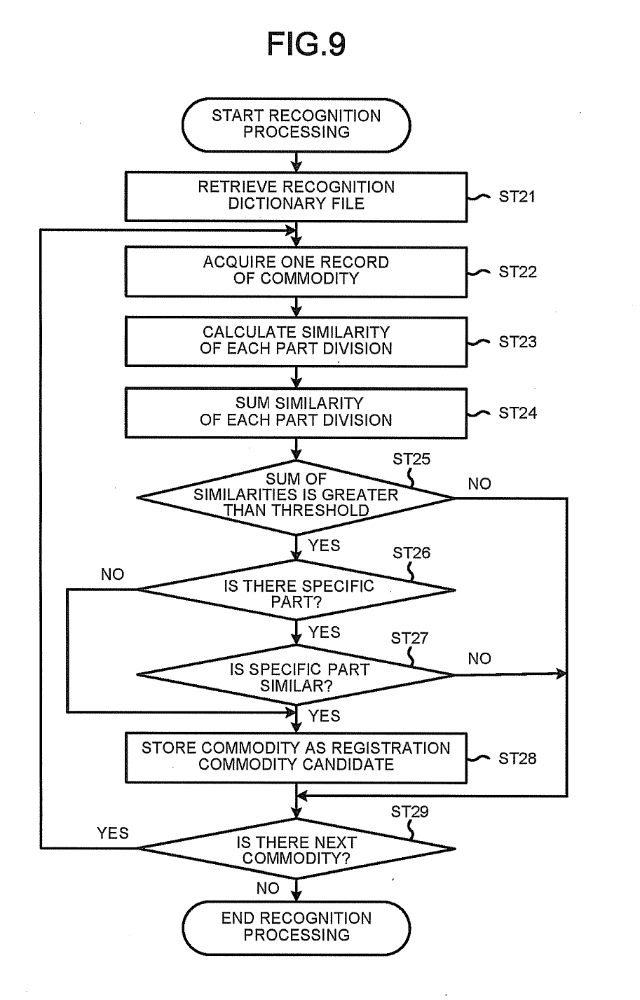

The second embodiment focusing on a specific part of a commodity is described with reference to FIG. 8 and FIG. 9. Like in the first embodiment, in the second embodiment, the commodity reading apparatus 1 has the function of a commodity recognition apparatus described in the first embodiment, and FIG. 1, FIG. 2, FIG. 4, FIG. 5 and FIG. 6 described in the first embodiment 1 can be utilized. Therefore, the same numerals are applied to similar elements in the second embodiment.

FIG. 8 is a schematic diagram illustrating the data structure of a recognition dictionary file 82 used in the second embodiment. Compared with the recognition dictionary file 81 (refer to FIG. 4) described in the first embodiment, the recognition dictionary file 82 in the second embodiment is different in that a flag f for identifying whether or not each part has specificity is added. The flag f is set to be 1 if a part specified by a corresponding part division has specificity (specific part), or 0 if a part specified by a corresponding part division has not. For example, flags of the leaf part and the white root part of the commodity ‘radish’ are set to be 0 because the two parts are not specific parts, while the green head part of the commodity ‘radish’ is set to be 1 because the green head part is a specific part.

FIG. 9 is a flowchart showing the procedure of a recognition processing (commodity recognition module 52) according to the second embodiment. In the processing, the ACTs ST21-ST25 are the same as the ACTs ST11-ST15 described in the first embodiment. That is, the CPU 101 retrieves the recognition dictionary file 82 (ST21) to read the data record (commodity ID, commodity name, flag f, feature amount data of each part division) of a commodity (ST22). If the data record is read, the CPU 101 calculates each similarity degree for the feature amount data of each part division in the record (ST23) and sums the similarity degrees of the feature amount data of each part division (ST24). Then, the CPU 101 determines whether or not the sum of similarity degrees is higher than a given threshold (ST25). If the sum of similarity degrees is not higher than the threshold (NO in ST25), the CPU 101 executes the ACT ST29.

If the sum of similarity degrees is higher than the threshold (YES in ST25), then the CPU 101 checks the data record to determine whether or not there is a flag f set to ‘1’, that is, whether or not there is a specific part (ST26). If flags f in the subject data record are all 0 (NO in ST26), the CPU 101 executes the ACT ST28.

If at least one flag f in the subject data record is set to 1 (YES in ST26), the CPU 101 determines the similarity degree between the feature amount data of the part division the flag of which is set to ‘1’ and the feature amount of the commodity surface information extracted from the image (ST27). If the similarity degree does not exceed 10%, the CPU 101 determines that the specific part is not similar (NO in ST27). The CPU 101 proceeds to execute the ACT ST29.

Contrary to this, in case that the similarity degree is above, for example, 10%, the CPU 101 determines that the specific part is similar to one another (YES in ST27). If the result obtained in the ACT ST27 is YES, the CPU 101 proceeds to execute the ACT ST28. That is, the CPU 101 stores the commodity ID and the commodity name in the subject data record in a given area of the RAM 104 as a registration commodity candidate. After executing the ACT ST28, the CPU 101 proceeds to execute the ACT ST29.

In the ACT ST29, the CPU 101 determines whether or not there is an unprocessed data record in the recognition dictionary file 82. If the CPU 101 determines that there is an unprocessed data record in the recognition dictionary file 82 (YES in ST29), the CPU 101 returns to execute the ACT ST22. That is, the CPU 101 reads the unprocessed data record from the recognition dictionary file 82. Then, the CPU 101 executes the processing shown in the ACTs ST23-ST29 for the subject data record.

In this way, when the processing shown in the ACTs ST22-ST29 is executed on all the data records stored in the recognition dictionary file 82 (NO in ST29), then the recognition processing is ended.

Like in the first embodiment, in the second embodiment, the commodity reading apparatus 1 calculates the similarity degree between the feature amount data of each of a plurality of part divisions of a commodity and the feature amount of each of the commodity surface information extracted from a captured image and determines whether or not the sum of the similarities is higher than a given threshold, thereby recognizing the commodity. Even if, however, the sum of the similarity degrees is higher than the given threshold, the commodity reading apparatus 1 confirm whether or not the similarity degree of the feature amount data of the part division of a specific part is higher than a given threshold as long as the feature amount data of the part division of the subject specific part of the commodity is processed. Then, the commodity reading apparatus 1 stores the commodity ID and the commodity name of the commodity in a given area as a registration commodity candidate if the similarity degree of the specific part is higher than the threshold, or excludes the commodity subject to the processing from the registration commodity candidate if the similarity degree thereof is not higher than the threshold.

In the case in which a commodity ‘radish’ is photographed by the image capturing module 14, since the similarity degree of the specific part of the commodity ‘radish’, that is, the green head part, is higher than the threshold on the data record of the commodity ‘radish’, thus, the commodity ‘radish’ becomes a registration commodity candidate. However, in the case in which a commodity ‘turnip’ is photographed by the image capturing module 14, the commodity ‘radish’ does not become a registration commodity candidate even if the sum of similarities of almost all part divisions of the data record of the commodity ‘radish’ except the part of the green head thereof is higher than a threshold, because the similarity degree of the green head part of the commodity ‘radish’ is not higher than the threshold. Therefore, the commodity reading apparatus 1 can recognize a commodity at a higher accuracy.

### Third Embodiment

In the second embodiment, the flag f for identifying the specific part of a commodity is set in the data item of the recognition dictionary file 82 (refer to FIG. 8). In the processing of the ACT ST26 that the CPU 101 executes, the CPU 101 determines whether or not there is a specific part of a commodity, using the flag f. If the CPU 101 determines that there is a specific part of the subject commodity, then checks the similarity degree between the feature amount data of the part division of the specific part and the feature amount of the commodity surface information extracted from the captured image calculated in the ACT ST27 (refer to FIG. 9). However, it is not always required to determine whether or not a commodity has a specific part with the flag f.

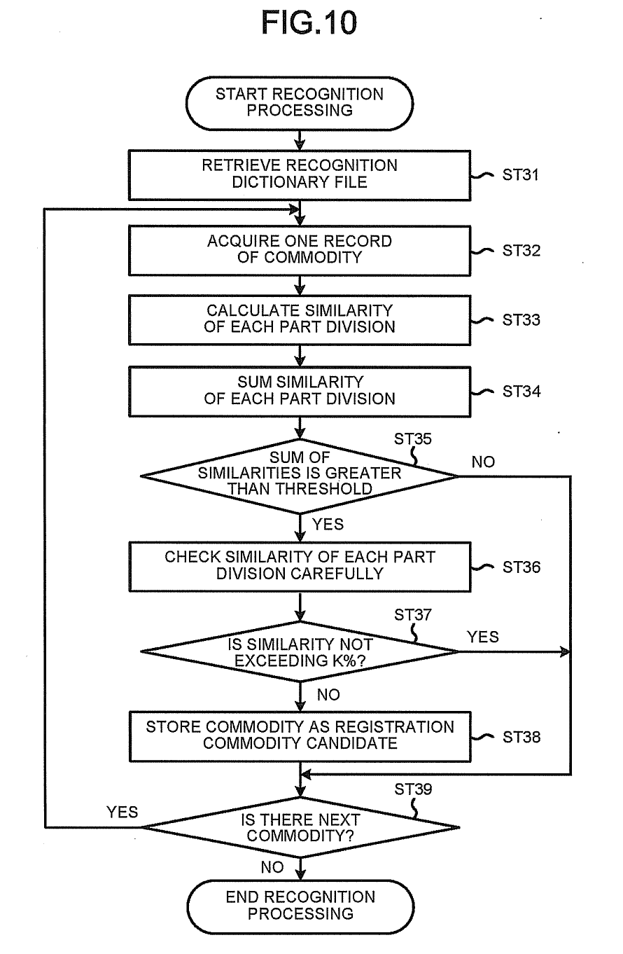

The third embodiment in which the flag f is not used is described with reference to FIG. 10. Like in the first and second embodiments, in the third embodiment, the commodity reading apparatus has the function of a commodity recognition apparatus, and FIG. 1, FIG. 2, FIG. 4, FIG. 5 and FIG. 6 described in the first embodiment are also used therein. Therefore, same numerals are applied to similar elements in the third embodiment. Furthermore, the data structure of the recognition dictionary file used in the third embodiment is the same as that of the recognition dictionary file 81 in the first embodiment.

FIG. 10 is a flowchart showing the procedure of a recognition processing (commodity recognition module 52) according to the third embodiment. The processing of the ACTs ST31-ST35 and the processing of the ACTs T38-ST39 in FIG. 10 are the same as those of the ACTs ST21-ST25 and the ACTs ST28-ST29 in FIG. 9 in the second embodiment. The CPU 101 retrieves the recognition dictionary file 81 (ST31) to read the data record (commodity ID, commodity name, feature amount data of each part division) of a commodity (ST32). When one data record is read, the CPU 101 calculates a similarity degree of each feature amount data of part divisions in the subject record (ST33) and sums the similarity degrees of the feature amount data of part divisions (ST34). Then, the CPU 101 determines whether or not the sum of the similarity degrees is higher than a given threshold (ST35). If the sum of the similarity degrees is not higher than the threshold (NO in ST35), the CPU 101 executes the processing of the ACT ST39.

If the sum of the similarity degrees is higher than the threshold (YES in ST35), the CPU 101 carefully checks the similarity degree of each feature amount data of part divisions (ST36). Then, the CPU 101 determines whether or not the similarity degree for at least one feature amount data of part divisions is not exceeding K % (ST37). The threshold K % is a value indicating a very low similarity degree, such as 3%, for example.

If the similarity degree for the at least one feature amount data of part divisions is not exceeding K % (NO in ST37), the CPU 101 executes the processing of the ACT ST39.

If the similarity degree for the at least one feature amount data of part divisions is above K %, the CPU 101 executes the ACT ST38. The CPU 101 stores the commodity ID and the commodity name of the commodity in the subject data record in a given area of the RAM 104 as a registration commodity candidate. Then, the CPU 101 executes the processing of the ACT ST39.

In the ACT ST39, the CPU 101 determines whether or not there is an unprocessed data record in the recognition dictionary file 82. If there is an unprocessed data record in the recognition dictionary file 82 (YES in ST39), the CPU 101 returns to execute the processing of the ACT ST32. The CPU 101 reads the unprocessed data record from the recognition dictionary file 82. Then, the CPU 101 executes the processing shown in the ACTs ST33-ST39 on the data record read.

In this way, the CPU 101 executes the processing shown in the ACTs ST32-ST39 on all the data records stored in the recognition dictionary file 82 and if the CPU determines that there is no unprocessed data record in the recognition dictionary file 82 (NO in ST39), then the recognition processing is ended.

Like in the first and second embodiments, in the third embodiment, the commodity reading apparatus 1 calculates the similarity degree between the feature amount data of each of a plurality of part divisions of a commodity and the feature amount of each of commodity surface information extracted from a captured image of a commodity and determines whether or not the sum of the similarity degrees is higher than a given threshold, thereby recognizing the commodity. However, even in the case in which the sum of the similarity degrees of the subject commodity is above the threshold, if the similarity degree for at least one feature amount data of part divisions does not exceed K %, that is, if the similarity degree of the part is low and so found not to be similar, then the commodity reading apparatus 1 excludes the subject commodity from the registration commodity candidate.

Like in the second embodiment, in the case that a commodity ‘radish’ is photographed by the image capturing module 14, for the data record of the commodity ‘radish’, the similarity degree of a specific part of the commodity ‘radish’, i.e., a green head part, is higher than K %, and thus, the commodity ‘radish’ becomes a registration commodity candidate. However, in the case that a commodity ‘turnip’ is photographed by the image capturing unit, for the data record of a commodity ‘radish’, even if the sum of the similarities of almost all parts of the commodity ‘radish’ is higher than a threshold, the similarity degree of the green head part does not exceed K %. Therefore, the commodity ‘radish’ does not become a registration commodity candidate. Thus, even no flag f is set in the data record of the recognition dictionary file 81, the commodity reading apparatus 1 can recognize a commodity at a higher accuracy.

The present invention is not limited to the embodiments described above.

For example, in the embodiments above, the commodity reading apparatus 1 separate from the POS terminal 2 has the function of a commodity recognition apparatus, however, the commodity reading apparatus 1 may be integrated in the POS terminal 2 to function as a commodity recognition apparatus. Alternatively, the POS terminal 2 and the commodity reading apparatus 1 may be separate from each other and the function of a commodity recognition apparatus is provided to the POS terminal 2. Alternatively, computer equipment connected with an image capturing unit such as a digital camera may be provided with the function of a commodity recognition apparatus by installing the commodity recognition program. In this case, the recognition dictionary file 81 or 82 may be stored in the internal memory device of the computer equipment or in the memory device of an external apparatus connected with the computer equipment in the form of an online.

The procedure of the processing executed by the CPU 101 in accordance with the commodity recognition program is not limited to those in the embodiments above. For example, in the second embodiment, the determination processing of the ACT ST25 may be executed after the determination processing in the ACT ST 27 the result of which is ‘YES’. Similarly, in the third embodiment, the determination processing of the ACT ST35 may be executed after the determination processing of the ACT ST37 the result of which is ‘NO’.

In the embodiments above, the similarity degree of each part division is summed, and a commodity having the sum of the similarity degrees higher than a threshold is selected as a registration commodity candidate, however, the method for selecting a registration commodity candidate is not limited to this. For example, the average of the similarities of all part divisions is calculated, and a commodity having an average similarity degree above a threshold may be selected as a registration commodity candidate. Other statistic methods such as a standard deviation method may be used instead of the average calculation method.

Although vegetables ‘radish’ and ‘turnip’ are described as an example in the embodiments above, the present invention is not limited to vegetables. For example, the present invention is also applicable to foods to be recognized such as fresh fish, bread and cooked dish as well as industrial parts such as bolt and nut.

Values used in the description of the embodiments above are example only but are certainly not a limitation to the present invention.

Further, in the embodiments above, a commodity recognition program is preinstalled in the ROM 103 serving as a program storage unit in the apparatus to achieve the functions of the present invention. However, the present invention is not limited to this, the same program can also be downloaded to the apparatus from a network, or the same program recorded in a recording medium can also be installed in the apparatus. The form of the recording medium is not limited as long as the recording medium can store programs like a CD-ROM and a memory card and is readable to the apparatus. Further, the function achieved by an installed or downloaded program can also be achieved through the cooperation with an OS (Operating System) installed in the apparatus.

While certain embodiments have been described, these embodiments have been presented by way of example only, and are not intended to limit the scope of the invention. Indeed, the novel methods and systems described herein may be embodied in a variety of other forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. A commodity recognition apparatus, comprising:
a feature amount extraction module configured to extract appearance feature amount of a commodity contained in an image photographed;
a commodity recognition module configured to compare the data of the appearance feature amount extracted by the feature amount extraction module with the feature amount data of each part of the commodity, representing a surface information in each part of the commodity subject to the recognition, which is previously stored in a recognition dictionary file, to recognize the commodity as a candidate of registration commodity contained in the image photographed; and
an output module configured to output the recognition result of the commodity recognition module.

2. The commodity recognition apparatus according to claim 1, wherein
the commodity recognition module calculates a similarity degree representing the degree of similarity of the appearance feature amount to the feature amount data of each part stored in the recognition dictionary file, and recognizes the commodity contained in the image based on the similarity degree of the feature amount data of each part of the commodity.

3. The commodity recognition apparatus according to claim 2, wherein
the commodity recognition module sums the similarity degree of feature amount data of each part of the commodity for each commodity and recognizes the commodity contained in the image based on the sum of the similarity degrees.

4. The commodity recognition apparatus according to claim 2, wherein
the commodity recognition module recognizes a commodity, having a specific part, which is contained in the image based on a similarity degree which is calculated for the feature amount data of the specific part within the similarity degrees which are calculated for each feature amount data of each part.

5. The commodity recognition apparatus according to claim 2, wherein
the commodity recognition module determines whether or not the similarity degree to the feature amount data of each part does not exceed a threshold.

6. A commodity recognition method performed by a commodity recognition apparatus having a recognition dictionary file, including:
extracting appearance feature amount of a commodity, subject to the recognition, which is contained in an image photographed;
recognizing the commodity as a candidate of registration commodity by comparing the data of the extracted appearance feature amount with the feature amount data of each part of the commodity representing a surface information in each part of the commodity stored in the recognition dictionary file; and
outputting the recognition result.

7. The commodity recognition method according to claim 6, wherein the recognizing the commodity includes:
calculating a similarity degree representing the degree of similarity of the appearance feature amount to the feature amount data of each part stored in the recognition dictionary file to recognize the commodity contained in the image based on the similarity degree of the feature amount data of each part of the commodity.

8. The commodity recognition method according to claim 7, wherein the calculating the similarity degree includes:
summing the similarity degree of feature amount data of each part in the commodity for each commodity, and the recognizing the commodity includes recognizing the commodity contained in the image based on the sum of the similarity degree.

9. The commodity recognition method according to claim 7, wherein the recognizing the commodity includes:
recognizing a commodity, having a specific part, which is contained in the image based on a similarity degree which is calculated for the feature amount data of the specific part within the similarity degrees which are calculated for each feature amount data of each part.

10. The commodity recognition method according to claim 7, wherein the recognizing commodity includes:
determining whether or not the similarity degree to the feature amount data of each part is not exceeding a threshold.
